(19) United States
(12) Patent Application Publication
(10) Pub. No.: US 2006/0018469 A1
(43) Pub. Date: Jan. 26, 2006

(54) Secure exportation from a global copy protection system to a local copy protection system

(75) Inventors: Alain Durand, Rennes (FR); Eric Diehl, Liffre (FR); Jean-Pierre Andreaux, Rennes (FR)

Correspondence Address: THOMSON LICENSING INC., PATENT OPERATIONS, PO BOX 5312, PRINCETON, NJ, 08543-5312, US

(73) Assignee: Thomson Licensing S.A., Boulogne-Billancourt (FR)

(21) Appl. No.: 10/530,898

(22) PCT Filed: Oct. 16, 2003
(86) PCT No.: PCT/EP03/50728

§ 371 Date: Apr. 11, 2005

(30) Foreign Application Priority Data
Oct. 16, 2002 (EP) 02292559.8

(51) Int. Cl. H04N 7/167

(52) U.S. Cl. 380/201

(57) ABSTRACT

The invention relates to a device for preventing illegal exportation of a content protected by a global copy protection system to a local copy protection system. According to the invention, each content liable to be exported contains a unique identifier and the device comprises a table for storing unique identifiers of all contents that have already been exported through said device. The invention also relates to a method for recording a content received by such a device. This method comprises the steps consisting, if the copy is to be made for a local copy protection system, in checking whether the unique identifier of said content is contained in the table of said device; and should said checking be positive, in preventing the recording; andshould said checking be negative, in recording the content and storing said unique identifier in said table.

### FIELD OF THE INVENTION

The invention relates generally to the copy protection problem. More particularly, the invention relates to a device and a method for preventing illegal exportation of a content from a global copy protection system to a local copy protection system.

### BACKGROUND ART

Copy Protection has been a hot topic for the last few years. First Copy Protection Systems (CPS) that have been studied rely on link encryption (see for example the “DTCP” proposal disclosed in “Digital Transmission Copy Protection Specification—Vol. 1 (Informational version)—Rev. 1.2—Jul. 11, 2001” available at the following internet address http://www.dtcp.com/data/info_dtcp_v1_{—}12_{—}20010711.pdf) or prerecorded/recordable media protection (see for example the “CPSA” proposal disclosed in “Content Protection System Architecture, A Comprehensive Framework for Content Protection—rev 0.81—Feb. 17, 2000” available at the following internet address http://www.4centity.com/data/tech/cpsa/cpsa081.pdf). These systems will be called “local CPS” in the following of the description.

The focus of Copy Protection has recently moved to a global security of the content through the home network and a new category of systems, that will be called “global CPS” in the following, has been investigated by normalization bodies (such as “DVB-CPT” or “TV-Anytime” forum) and industry efforts (see for example the “SmartRight” proposal disclosed in “SmartRight Technical white paper—version 1.0—Oct. 29, 2001”).

Local CPS usually have four different usage rules:
“copy-free” (one may copy the content without any limitations),
“copy-never” (one may not copy the content),
“copy-once” (one may copy only once the content),
“copy-no-more” (one may not copy the content because it is the copy of a “copy-once” content or an already copied “copy-once” content).

However, because of implementation difficulties, the “copy-once” usage rule has often been replaced by “copy-one-generation” usage rule (one may copy only the original content), leading to a much wider possible use of the content than expected.

Global CPS replace the “copy-once” or “copy-one-generation” and “copy-no-more” usage rules with the “private-copy” usage rule. The “private-copy” usage rule allows to make as many copies as desired but the copy will be only usable within the home network wherein it has been created. That usage rule is easy to implement and in line with both users and content owners interiests.

One problem encountered with these systems is due to the fact that global CPS coexist with local CPS. A user may want to export a “private-copy” content from a global CPS to a local CPS. For instance, a user may want to make a back-up copy from a “private-copy” content created in a global CPS on an optical disc (such as a DVD—acronym of “Digital Versatile Disc”—or a BRD—acronym of “Blu-Ray Disc”) protected by a local CPS. The “private-copy” usage rule in the global CPS is logically changed to the “copy-no-more” usage rule in local CPS. But this is insufficient since as many “copy-no-more” copies as desired can be created from the “private-copy” content. This feature is clearly in contradiction to the copy-no-more usage rule.

It is therefore an object of the present invention to provide a method ensuring that a content protected by a global CPS and labeled “private-copy” cannot be exported (as a “copy-no-more” content”) an unlimited number of times to a local CPS.

### SUMMARY OF THE INVENTION

The main idea of the invention is to associate a Content Unique Identifier (CUI) to any content entering a home network protected by a global CPS. This CUI will be checked when the content will leave the global CPS for a local CPS.

More particularly, the invention relates to a device for preventing illegal exportation of a content protected by a global copy protection system to a local copy protection system, characterized in that each content liable to be exported contains a unique identifier and in that the device comprises an exportation table for storing unique identifiers of all contents that have already been exported through said device.

The invention also relates to a method for recording a content received by a device as above-mentioned, characterized in that it comprises the steps consisting, if the copy is to be made for a local copy protection system, in checking whether the unique identifier of said content is contained in the exportation table of said device; and
should said checking be positive, in preventing the recording; and
should said checking be negative, in recording the content and storing the unique identifier in the exportation table.

The invention further relates to a device adapted to be linked to a local network protected by a global copy protection system and to convert a content it receives into a content protected by the global copy protection system, characterized in that the device is furthermore adapted to generate a unique identifier for each content it converts, the unique identifier being inserted in a part of the content protected by encryption or by authentication

Thanks to the invention, it is possible to control the number of local CPS-protected copies created from a global CPS-protected content.

### BRIEF DESCRIPTION OF THE DRAWINGS

The various features and advantages of the present invention and its preferred embodiments will now be described with reference to the accompanying drawings which are intended to illustrate and not to limit the scope of the present invention and in which:

FIG. 1 illustrates the environment of the invention and the principle of exportation of a content protected by a global CPS to a content protected by a local CPS; and

FIG. 2 is a flowchart illustrating the behavior of a device carrying out the exportation process.

### DESCRIPTION OF THE PREFERRED EMBODIMENTS

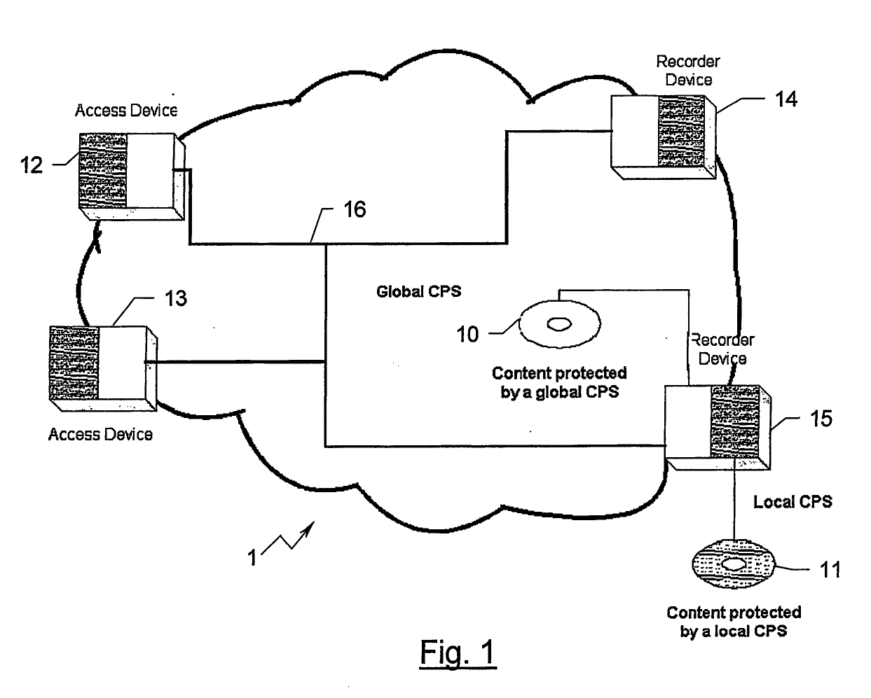

FIG. 1 illustrates the environment of the invention. It may be for example a digital home network 1 protected by a global CPS, this network comprising two Access Devices 12, 13 and two Recorder Devices 14, 15 linked together by a digital bus 16.

The principles of protection of the data by the global CPS in the home network are disclosed in documents FR-A-2 792 482 and FR-A-2 824 212.

Interactions between local and global CPS are ensured thanks to the following devices:
the Access Devices that receive local CPS-protected contents from the outside of the network and convert them into global CPS-protected contents; and
the Recorder Devices that create either global CPS-protected copies or local CPS-protected copies 11.

We will now describe more particularly the Access Devices behavior and the Recorder Devices behavior according to the principles of the invention.

1. Access Devices Behavior

Each time an Access Device is required to convert a local CPS-protected content it receives from the outside of the network into a new global CPS-protected content, it generates a Content Unique Identifier associated with this new content. It then inserts the CUI in the content, preferably in a part of the content protected by encryption or authentication.

The CUI may be “probably unique” (for example a large size random number generated by a pseudo-random generator) or “actually unique”. In the latter case, Access Devices should be given a unique identifier at their installation in the network. This identifier will be the first part of the CUI. The second part will be a counter maintained by the Access Device. The CUI is preferably at least 80 bits long.

2. Recorder Devices Behavior

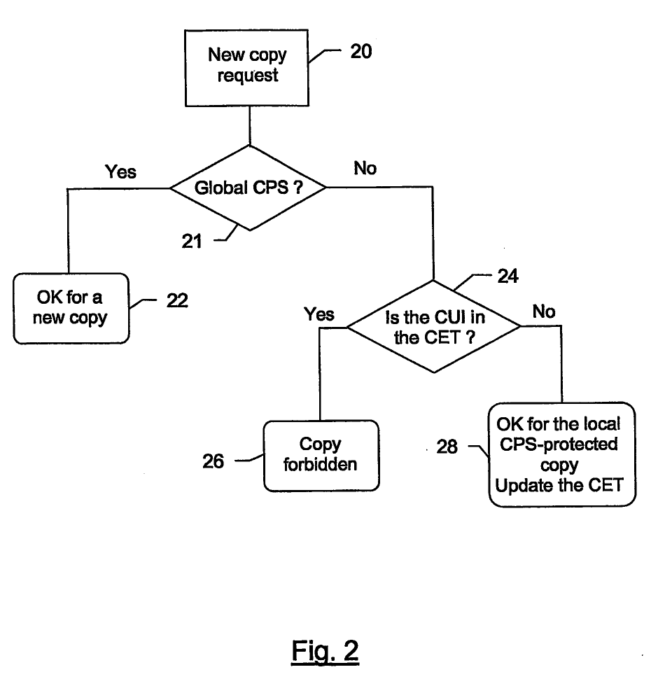

This behavior is illustrated by the flowchart of FIG. 2.

A Recorder Device is capable of recording a content having a “private-copy” status and created in the network protected by the global CPS to create a local CPS-protected copy of this content.

According to the invention, each Recorder Device has a Content Exportation Table (CET) storing all the CUIs of local CPS-protected content that have already been created. This CET is preferably stored in a protected or secure memory of the Recorder Device. It can also be stored in an encrypted or authenticated form in a conventional non-secure memory of the Recorder Device. In the latter case, only the encryption key or authentication key used to encrypt or authenticate the CET need to be stored in a secure memory, for example a memory included in a smart card.

As illustrated in FIG. 2, each time the recorder device is requested to create a new copy of a “private-copy” content (step 20), a test is carried out at step 21 to check whether the copy remains protected by the global CPS or not. If the copy remains global CPS-protected (i.e. the copy is destined to be used in the home network 1 protected by the global CPS), then the recorder simply duplicates this content (step 22). Otherwise, if the new copy is a local CPS-protected content (i.e. a copy to be used outside the network 1 in another system protected by a local CPS) then, the Recorder Device first extracts the CUI from the content and checks whether it is already in its CET or not (step 24). In order to extract the CUI from the content, the Recorder Device contains the necessary encryption or authentication keys that have been used to insert the CUI in a protected part of the content or is able to recover them. If the extracted CUI is already in the CET of the Recorder Device, the content is blocked and the copy does not takes place (step 26). Else, the Recorder Device adds the CUI in the CET and creates the copy. The local CPS should treat the copy as a “copy-no-more” or “copy-never” content.

It is also possible to allow the Recorder Device to make more than a single local CPS-protected copy of a given “private-copy” content. In this case, the CET will store with each CUI, a counter of the number of local CPS-protected copies made for this content, this counter being incremented each time a local CPS-protected copy is made for this content. When the maximum number of allowed copies is reached for a given content, then the Recorder Device will not make any more local CPS-protected copy of this content.

According to a variant embodiment, only a limited number of Recorder Devices is authorized to make copies protected by a local CPS in a home network such as network 1. Preferably, only one Recorder Device per network is authorized to make copies protected by a specific local CPS. These Recorder Devices are called exportation devices. In FIG. 1, Recorder Device 15 is an exportation device. The Recorder Devices that can create only global CPS-protected copies are called storage units. Recorder Device 14 of FIG. 1 is a storage unit. In this preferred embodiment, only the exportation devices have a CET for storing the CUI of contents already copied with a local CPS protection.

We suppose now that the global CPS is the SmartRight™ system (“SmartRight” is a trademark of THOMSON) disclosed in the documents previously mentioned (FR-A-2 792 482 and FR-A-2 824 212) and in a further document WO-A-03 019899.

The Access Devices illustrated in FIG. 1 comprise converter cards (not illustrated in FIG. 1) which are in charge of creating messages called LECM (acronym of “Local Entitlement Control Message”). The LECMs contain control words CW which are used to scramble the content entering the home network through an Access Device. These CW are contained in a part of the LECM which is protected (preferably by encryption with a key or with keys specific to the network).

According to the present invention, the converter card randomly chooses the CUI during the LECM building step when a content is received in the network by an Access Device. The CUI is then placed in the protected part of the LECM.

Recorder Device 15 which is an exportation device comprises a terminal card (not illustrated). This terminal card is a smart card, i.e. a card with a secure microprocessor, containing the key(s) necessary to decrypt the protected part of the LECM and it furthermore contains, according to the invention, the CET for storing the CUI of the contents already copied by Recorder Device 15 with a local CPS protection.

When Recorder Device 15 receives a new content (having a “private-copy” status) to be exported (i.e. to be used to perform a local CPS-protected copy of this content), its terminal card first checks whether the CUI contained in the first LECM associated with this content is already in its CET or not. If yes, the terminal will output a message forbiding the copy. Else, it will add the CUI in the CET and then output a message authorizing the copy.

Preferably, the CET is not erased after a terminal card reinitialization.

1. Device for preventing illegal exportation of a content protected by a global copy protection system to a local copy protection system, wherein each content liable to be exported contains a unique identifier and wherein the device comprises an exportation table for storing unique identifiers of all contents that have already been exported through said device.

2. Device according to claim 1, wherein the unique identifier is contained in a part of the content protected by encryption or authentication and wherein the device further comprises means for extracting said unique identifier from the content.

3. Device according to claim 1, wherein the exportation table is stored in a secure memory of the device.

4. Device according to claim 1, wherein the exportation table is stored in an encrypted or authenticated form in a conventional memory of the device and wherein the encryption key or authentication key used to encrypt or authenticate the exportation table is stored in a secure memory.

5. Device according to claim 1 intended to be used in a local network protected by a global copy protection system, wherein there are a limited number of such devices in the network.

6. Device according to claim 5, there is only one such device in the network.

7. Device according to claim 1, wherein the exportation table stored in said device further contains, for each unique identifier a counter of the number of exportations of the content associated with said unique identifier, this counter being incremented each time an exportation is made through said device.

8. Method for recording a content received by a device according to claim 1, said method comprising the steps consisting, if the copy is to be made for a local copy protection system, in:
checking whether the unique identifier of said content is contained in the exportation table of said device; and
should said checking be positive, then preventing the recording; and
should said checking be negative, then recording the content and storing said unique identifier in said exportation table.

9. Method for recording a content received by a device according to claim 7, said method comprising the steps consisting, if the copy is to be made for a local copy protection system, in:
(a) checking whether the unique identifier of said content is contained in the exportation table of said device; and
should said checking of step (a) be positive, then
(b) checking whether a predetermined maximum number of authorized copies has been reached by the counter associated with the unique identifier, and
in case the maximum number of copies has been reached, then preventing the recording; and
in case the maximum number of copies has not been reached, then incrementing the counter and recording the content; and
should said checking of step (a) be negative, then recording the content and storing said unique identifier (CUI) in said exportation table.

10. Device adapted to be linked to a local network protected by a global copy protection system and to convert a content it receives into a content protected by said global copy protection system, wherein said device is furthermore adapted to generate a unique identifier for each content it converts, the unique identifier being inserted in a part of the content protected by encryption or by authentication.
